(19) United States
(12) Patent Application Publication
(10) Pub. No.: US 2026/0158482 A1
(43) Pub. Date: Jun. 11, 2026

(54) THERMAL DECOMPOSITION OF AMMONIUM PERCHLORATE USING MAGNETIC NANOPARTICLES FUNCTIONALIZED WITH AMINE DERIVATIVES AS CATALYSTS

(71) Applicant: UNIVERSIDAD BERNARDO O'HIGGINS, Santiago (CL)

(72) Inventors: José GAETE, Santiago (CL); Gabriel ABARCA, Santiago (CL); César MORALES-VERDEJO, Santiago (CL)

(21) Appl. No.: 18/724,533

(22) PCT Filed: Dec. 26, 2022
(86) PCT No.: PCT/CL2022/050136

§ 371 Date: Jun. 26, 2024

Related U.S. Application Data
(60) Provisional application No. 63/266,028, filed on Dec. 27, 2021.

(51) Int. Cl. B01J 31/28; B01J 31/02; B01J 35/33; B01J 35/45; B01J 37/03; C06B 23/00; C06B 29/22

(52) U.S. Cl. CPC B01J 31/28; B01J 31/0237; B01J 31/0239; B01J 35/33; B01J 35/45; B01J 37/03; C06B 23/007; C06B 29/22; B01J 2235/30

(57) ABSTRACT

The invention relates to the use of nanocatalysts with a high catalytic activity for the thermal decomposition of ammonium perchlorate (AP). To obtain these materials, magnetite nanoparticles (Fe₃O₄ NPs) were functionalized with two different groups of amine derivatives, tertiary amine (Fe₃O₄ NPs-A1) and quaternary amine (Fe₃O₄ NPs-A2). These nanocatalysts allow a lower activation energy to be obtained, accelerating the thermal decomposition of ammonium perchlorate.

### FIELD OF INVENTION

The invention relates to the chemical industry, in particular, to the fuel and explosives industry. The invention relates to the use of a nanocatalyst or catalyst consisting of magnetic nanoparticles functionalized with amine-derived groups to accelerate the thermal decomposition of ammonium perchlorate for use as a rocket fuel oxidizer.

### BACKGROUND

Rocket technology has seen great interest from government research institutions and has led private companies to develop new technologies related to aerospace equipment to expand human exploration to the Moon and Mars. NASA, for example, has developed a transportation plan with private industries to reach Mars by 2030.

One of the relevant areas of development in this industry is chemical propellants.

To be efficient, a propellant must have a high heat of combustion to produce high temperatures and combustion products containing simple, lightweight molecules. Another important factor of a propellant is its density, as a dense propellant can be transported in a smaller, lighter tank.

Other criteria must also be considered when choosing rocket propellants, some create problems in engine operation, others exhibit combustion particularities that make them difficult or impossible to use, and some are unstable and cannot be safely stored or handled. Most of the propellants that have a good performance are chemically very active, therefore, most of the good propellants are corrosive, flammable and/or toxic.

Another characteristic for choosing a rocket propellant is its availability and abundance of raw materials.

In the case of solid propellants, two types are used. The first, the so-called dual-base propellant, consists of nitrocellulose and nitroglycerin, plus additives in low quantities. The molecules are unstable and, when ignited, break and rearrange, releasing large amounts of heat. These propellants are suitable for smaller rocket engines.

The other type of solid propellant is the so-called composite, where the fuel and oxidizer are found separately, intimately mixed in the solid grain. The oxidizer generally corresponds to up to four-fifths or more of the total propellant mixture. Much of the research on solid propellants has been devoted to improving the physical and chemical properties of the fuel.

Normally, in compound (composite type) solid propellants, they consist mainly of an oxidizing agent, salts with a high oxygen content, such as nitrates or perchlorates; a metallic fuel such as powdered aluminum; A polymer such as hydroxyl-terminated polybutadiene (HTPB) is commonly used as a binder and organic fuel and, to a lesser extent, combustion rate catalysts that improve the performance of the rocket engines. The mixture is prepared under controlled conditions and then poured into the rocket as a viscous semi-solid, where it is finally set in curing chambers under controlled temperature and pressure. Solid propellants may require controlled storage conditions and may present handling problems in very large volumes. Protection against mechanical shocks or sudden changes in temperature is essential.

The use of burning rate (BR) catalysts in rocket engines allows for a significant reduction in launch weight in piloted or non-piloted space missions.

The objective of a catalyst is to reduce the temperature at which the oxidizing agent must be delivered so that its thermal decomposition occurs and releases its heat energy, which is the energy used to propel the rocket.

Ammonium perchlorate (NH₄ClO₄, AP ammonium perchlorate) has been widely used as an oxidizer due to its high propellant capabilities. In addition, at room temperature perchlorates remain stable, but at high temperatures they begin to react producing a large amount of heat energy.

A BR catalyst is evaluated for its impact on decreasing the thermal degradation temperature of the AP. Currently, BR catalysts include metal nanoparticles, metal chelates, and ferrocene derivatives.

The invention aims at the use of new catalyst compounds for the thermal decomposition of the AP, improving the efficiency of said decomposition, by decreasing the required temperature and increasing the caloric energy released.

### STATE OF THE ART

In recent years, iron oxide nanoparticles have been gaining interest as combustion modifiers, because they have a higher catalytic activity than macroscopic catalysts. Within this oxide group, promising results have been reported using magnetite (Fe₃O₄ NPs) and maghemite (γ-Fe₂O₃ NPs) nanoparticles as catalysts for thermal decomposition of APs.

In the field of propellants, Wang et al. (Chem. Lett. 2014, 43 (10), 1554-1556. https://doi.org/10.1246/cl.140602) reported the use of Fe₃O₄ as a catalyst for thermal decomposition of the AP. In their studies, they showed that the presence of Fe₃O₄ produced a decrease in the high temperature decomposition (HTD), thus promoting the thermal decomposition of the AP. This phenomenon would be associated with the oxidation of NH₃ by ClO₄— and the surface decomposition of the AP crystal, whose generated ions could be adsorbed on the surface of the catalyst.

In addition, γ-Fe₂O₃ NPs and other derivatives of iron oxides have been studied in this field, mainly due to the extensive use as propellants of their macroscopic counterparts. It has been reported that the higher efficiency of γ-Fe₂O₃ NPs as a catalyst is mainly based on its large surface area, which allows for a greater number of available active oxygen sites that contribute to an increase in its catalytic activity. Several studies have reported that the use of γ-Fe₂O₃ NPs as a catalyst in AP-based propellants promotes the decrease of HTD and increases the mass loss of AP.

Nanoparticles tend to form aggregates in systems with high surface tension to decrease their area/volume ratio. In addition, Fe₃O₄ NPs may suffer partial or total loss of their magnetization under an oxidizing or acidic environment due to the decomposition of the mixed oxide or transformation to other species, such as γ-Fe₂O₃ or goethite (α-FeO(OH)).

Although in the previous art there are some approximations to the technical problem described in the present invention, not all alternatives are characterized by providing a catalyst capable of efficiently accelerating the thermal decomposition of ammonium perchlorate as an oxidant.

As a solution, stabilization with chemical agents that can be fixed to the surface of nanoparticles by chemical or physical adsorption has been proposed. Thus, a more stable system is achieved due to the additional effect of steric repulsion and the dipole and Van der Waals interactions that exist between the nanoparticles.

### BRIEF DESCRIPTION OF THE FIGURES

FIG. 1. Chemical structures of (a) Fe₃O₄ NPs-A1 and (b) Fe₃O₄ NPs-A2.

Note FIG. 1: Chlorine and iodine are only against spectator ions, as they do not present an effect on catalysis in the thermal decomposition of AP.

FIG. 2. DSC (Differential Scanning calorimetry) curves of AP with different weight percentages of (a) Fe₃O₄ NPs, (b) Fe₃O₄ NPs-A1, and (c) Fe₃O₄ NPs-A2.

FIG. 3. AP DSC curves with (a) Fe₃O₄ NPs, (b) Fe₃O₄ NPs-A1, and (c) Fe₃O₄ NPs-A2 at different heating rates.

### DESCRIPTION OF THE INVENTION

The invention provides functionalized magnetite nanoparticles for use as a catalyst in the thermal decomposition of ammonium perchlorate (AP), which is used as an oxidizer in solid propellant composites for rockets.

Magnetite nanoparticles are functionalized with the tertiary (Fe₃O₄ NPs-A1) and quaternary (Fe₃O₄ NPs-A2) amine groups.

The amine-derived functional group present in the nanoparticles generates strong interactions through hydrogen bonds between the catalyst and the propellant components (AP and binder), reducing migration problems. In addition, the presence of nitrogen atoms in catalysts increases the combustion rate of AP-based propellants.

### Nanocatalyst

The nanocatalyst for the thermal decomposition of the AP according to the present invention comprises magnetite nanoparticles (Fe₃O₄ NPs) functionalized with groups of amine derivatives, which correspond to tertiary amine (Fe₃O₄ NPs-A1) and quaternary amine (Fe₃O₄ NPs-A2).

The groups derived from tertiary and quaternary amines contain alkyl chains (n=1-4 carbons) as substitutes, with the aim of obtaining a hydrophilic nanocatalyst that can interact efficiently with the other components of the solid propellant.

The size of the nanoparticles is in the range between 4 and 10 nm, forming agglomerates of approximately 20 nm.

The degree of functionalization of Fe₃O₄ NPs-A1 and Fe₃O₄ NPs-A2 is between 2 to 10%, leading to a decrease of between 50 to 90° C. compared to the use of pure AP.

### Nanocatalyst Development Process

The process for developing an active nanocatalyst for the thermal decomposition of ammonium perchlorate in accordance with the present invention comprises the steps of:
a) Making magnetite nanoparticles (Fe₃O₄ NPs); and
b) Functionalizing magnetite nanoparticles with tertiary (Fe₃O₄ NPs-A1) or quaternary (Fe₃O₄ NPs-A2) amine groups,
   where magnetite nanoparticles are preferably made by a method of coprecipitation of iron salts, at a temperature between 70 to 90° C. for 20 to 60 minutes.

The functionalization step with the tertiary amine group is carried out by mixing the compound with the amino groups, such as N,N dimethylglycine hydrochloride with magnetite nanoparticles under an atmosphere of N₂, where the solvent is water and the temperature is preferably between 70 to 90° C. The mixing is performed for between 2 to 4 hours.

The functionalization stage with the quaternary amine group is carried out in the following steps:
i. mixing the compound with the amino groups, for example, glycine, with magnetite nanoparticles where the solvent is water; where the water is preferably between 70 to 90° C., and
ii. performing the alkylation reaction of the primary amine group present in the chemical structure of the compound with the amino groups, where the alkylation is carried out in the acetonitrile solvent at room temperature.

These nanoparticles are mixed with AP in proportions between 1 to 5% by weight, by mechanical means, and act as catalysts in the thermal decomposition of this oxidizing agent.

### Advantages

Magnetite nanoparticles functionalized with tertiary amine (Fe₃O₄ NPs-A1) and quaternary amine (Fe₃O₄ NPs-A2) groups decrease the decomposition temperature by about 80° C. and 75° C., respectively, compared to pure ammonium perchlorate.

In addition, the values of the heat release ratio of the ammonium perchlorate plus nanoparticle mixture are in the range of 1.3-1.5 times higher compared to pure ammonium perchlorate.

Magnetite nanoparticles provide a bridge for electron transfer from perchlorate ions to ammonium ions, thereby decreasing the activation energy of AP thermal decay. On the other hand, the amine groups continue with the process of proton transfer, which would explain the catalytic difference between the two amine-derived groups.

These results suggest a synergistic effect of the properties of magnetite and groups of amine derivatives, resulting in a material with high catalytic activity in the thermal decomposition of AP.

### EXAMPLES

### Example 1. Catalyst Synthesis

A coprecipitation method was used to produce magnetite nanoparticles (Fe₃O₄ NPs) with improved performance. The precipitation reaction was carried out at a temperature of 80° C. for 30 minutes.

The functionalization of Fe₃O₄ NPs with tertiary (Fe₃O₄ NPs-A1) and quaternary (Fe₃O₄ NPs-A2) amine groups was performed according to the following procedure:

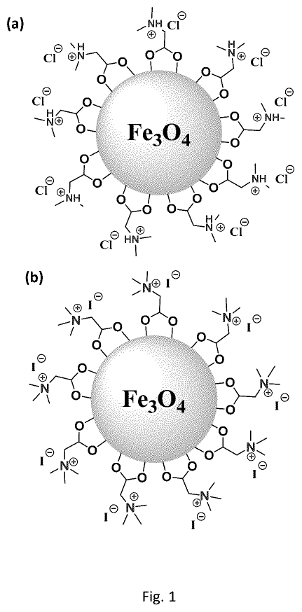

To obtain the Fe₃O₄ NPs-A1 catalyst (FIG. 1.a), N,N dimethylglycine hydrochloride and Fe₃O₄ NPs were mixed in water for 3 h at 80° C. under an atmosphere of N₂.

To synthesize the Fe₃O₄ NPs-A2 catalyst (FIG. 1.b), in the first stage, glycine was incorporated into the surface of Fe₃O₄ NPs using water as a solvent at 80° C., for 30 minutes. In a second stage, the alkylation of the primary amine group present in the chemical structure of glycine was carried out in acetonitrile at room temperature.

### Example 2. Characterization of Nanoparticles

The XPS analysis was performed with a Physical Electronics Model 1257 Photoelectron Spectrometer. The chamber pressure during measurements was 5×10−9 Torr. Wide-range scans were collected with a pass energy of 80 eV in hybrid slot lens mode and a pass size of 0.5 eV.

High-resolution XPS data on the peaks corresponding to C 1s, O 1s, N 1s and Fe 2p were collected at a step energy of 20 eV. The X-ray source was a monochromatic Al Ka radiation executed at 120 W.

Transmission electron microscopy (TEM): A Hitachi 1200 transmission electron microscope was used, which operates at 100 kV. Samples for TEM analysis were prepared on a Cu grid.

X-ray diffraction (XRD) analysis was performed with a Bruker D8 ADVANCE device.

The N₂ adsorption-desorption isotherms of nanocatalysts were determined from N₂ physisorption measurements on the 3Flex equipment (Version 4.02), Micromeritics Instrument Corporation.

It was observed that the nanocatalysts Fe₃O₄ NPs-A1 and Fe₃O₄ NPs-A2 have a similar average size about 6-8 nm.

TGA measurements allowed for the quantifying of the degree of surface functionalization, reporting an average value of 6% by weight for Fe₃O₄ NPs-A1 Fe₃O₄ NPs-A2.

The X-ray photoelectron spectroscopy (XPS) spectra obtained in the initial scan are consistent with the chemical elements that constitute Fe₃O₄ NPs-A1 and Fe₃O₄ NPs-A2.

The isotherms obtained by N₂-physisorption experiments revealed an increase in the surface area and pore volume of the amine-functionalized magnetite nanoparticles (Fe₃O₄ NPs-A1 and Fe₃O₄ NPs-A2) compared to the precursor Fe₃O₄ nanoparticles.

### Example 3. Thermal Analysis

DSC analyses were performed with a METTLER TOLEDO DSC 822e instrument at a heating rate of 5° C.·min⁻¹ under nitrogen atmosphere, in the range of 80-500° C. 40 μL aluminum trays were used to deposit the sample.

To analyze the catalytic efficiency of the functionalized magnetite nanoparticles, specific amounts of nanoparticles and AP were mixed and ground into a certain weight ratio for DSC analysis.

It was compared with commercial-grade AP with a particle size of 200 μm, supplied by SNPE Propulsion, Groupe SNPE.

The activation energy (Eₐ) analysis was carried out using the ASTM e628 method. Samples were heated from 140° C. to 450° C. with a heating rate of 2, 5, and 10° C. min⁻¹. The temperatures of the maximum reaction peaks were corrected for the nonlinearity of the temperature scale. The relationship Log₁₀ β(heating rate, K·min⁻¹) versus 1/T was plotted, where T is the maximum temperature in Kelvin. The calculation and construction of the best linear fit was carried out considering the values of least squares through these points. The slope of this “best fit” line was taken as the value for d(Log₁₀ β/d(1/T). The value of Eₐ (activation energy) was determined according to the following Equation 1:

$${E}_{a} = - 2.19 R [ d {log}_{10} β / d ( 1 / T ) ] \qquad [ Equation 1 ]$$

$$Where R = gas constant ( = 8.314 J \cdot {mol}^{- 1} {K}^{- 1} ) .$$

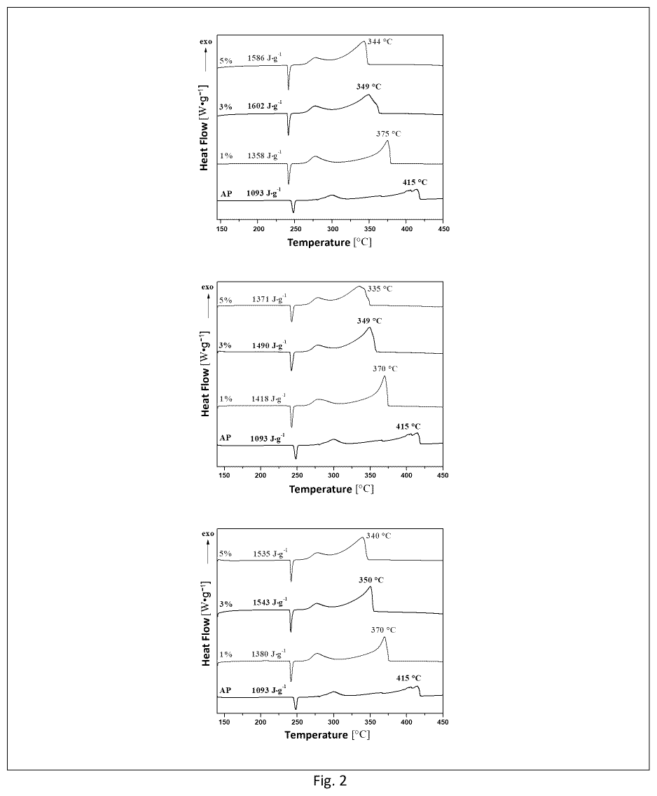

FIG. 2 shows the DSC curves for a heating rate of 5° C. min⁻¹. under an atmosphere of N₂ in the range of 140-450° C. of both AP and AP mixing with nanoparticles. The weight percentages of the mixtures used were 1, 3 and 5% by weight. All reported nanoparticles reduced the thermal decomposition temperature of AP and increased its released heat.

As shown in FIG. 2, the endothermic process of the phase transition of the AP at 243° C. had almost no displacement and exhibited a similar profile with 1-5% by weight of Fe₃O₄ NPs, Fe₃O₄ NPs-A1 and Fe₃O₄ NPs-A2.

On the other hand, the HTD of the AP at 415° C. is considerably affected by catalysts, where the best catalytic results were obtained at 5% by weight. The HTDs obtained were 344, 335 and 340° C. for Fe₃O₄ NPs, Fe₃O₄ NPs-A1 and Fe₃O₄ NPs-A2, respectively; that is to say, they decreased by 71, 80 and 75° C. compared to pure AP.

The results reveal that Fe₃O₄ NPs-A1 and Fe₃O₄ NPs-A2 have a better catalytic effect on thermal degradation of AP compared to the reported magnetite nanoparticles, as shown in Table 1.

TABLE 1
Summary of the effect of the different catalysts on
the thermal degradation of the 5% AP by weight.

| | WT | HTD de AP | Heat released |
|---|---|---|---|
| Compounds | [%] | (° C.) | (J · ^{g-1}) |
| NH₄ClO₄ (AP) | | 415 | 1093 |
| Fe₃O₄ NPs | 5 | 344 | 1586 |
| Fe₃O₄ NPs-A1 | 5 | 335 | 1371 |
| Fe₃O₄ NPs-A2 | 5 | 340 | 1535 |
| Fe₂O₃ | 5 | 352 | 1839 |
| Fe₃O₄ NPs rods | 5 | 366 | — |
| Fe₃O₄ NPs nanosheets | 5 | 399 | — |
| Fe₃O₄ NPs nanowires | 4 | 368 | — |
| NanoFe₂O₃² | 5 | 373 | 1447 |
| NanoMnFe₂O₄⁴ | 5 | 345 | 1164 |
| NanoMnCo₂O₄⁶ | 5 | 360 | 1215 |

WT [%]: percentage by weight of the catalyst; HTD: Thermal Decomposition Temperature.

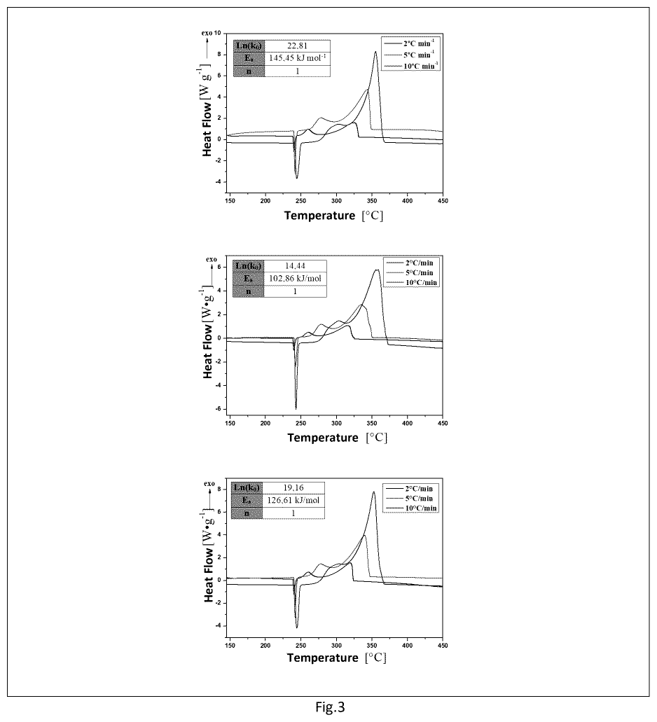

Activation energy (Eₐ) was also measured as shown in Table 2. The samples were heated from 140° C. (rate 2, 5, 10° C. min⁻¹), where the values of Eₐ obtained are shown in FIG. 3. The lowest activation energy (102 kJ·mol⁻¹) indicates a low degree of thermal stability, accelerating the thermal decomposition of AP.

According to what is presented in Table 2, the decrease in HTD of AP in the presence of nanoparticles is shown according to the present invention.

TABLE 2
Activation energy (Eₐ) of pure AP and mixtures with nanocatalysts.

| | WT | HTD de AP | Eₐ |
|---|---|---|---|
| Compounds | [%] | (° C.) | (kJ · mol⁻¹) |
| AP | | 415 | 245.8 |
| Fe3O4 NPs | 5 | 344 | 145.5 |
| Fe3O4 NPs-A1 | 5 | 335 | 102.9 |
| Fe3O4 NPs-A2 | 5 | 340 | 126.6 |

WT [%]: percentage by weight of the catalyst;
HTD: thermal decomposition temperature;
Eₐ: Activation Energy

The degree of functionalization of Fe₃O₄ NPs-A1 and Fe₃O₄ NPs-A2 was around 6%, leading to a decrease of 77° C. on average compared to pure AP. In addition, nanoparticles functionalized with the tertiary amine group (Fe₃O₄ NPs-A1) had a higher catalytic effect than those functionalized with the quaternary amine group (Fe₃O₄ NPs-A2).

1-9. (canceled)

10. A method to catalyze the thermal decomposition of ammonium perchlorate, comprising mixing ammonium perchlorate (PA) with 5% magnetite nanoparticles (Fe₃O₄ NPs) functionalized with groups of amine derivatives, where the degree of functionalization of magnetite nanoparticles with groups of amine derivatives is between 2 to 10%.

11. The method according to claim 10, wherein the amine-derived groups correspond to tertiary amine (Fe₃O₄ NPs-A1) and quaternary amine (Fe₃O₄ NPs-A2).

12. The method according to claim 11, wherein the groups derived from tertiary and quaternary amines contain as substituents alkyl chains of 1-4 carbons.

13. The method according to claim 12, wherein the substituent is methyl.

14. The method according to claim 12, wherein the size of the functionalized magnetite nanoparticles is between 4 to 10 nm.

15. The method according to claim 10, wherein the resulting product is useful as a solid composite propellant for rockets.

16. The method according to claim 10, wherein the decomposition temperature of the ammonium perchlorate is lowered by about 50 to 90° C.

17. The method according to claim 10, wherein the heat release ratio of ammonium perchlorate is increased by about 1.3-1.5 times.
